(19) United States
(12) Patent Application Publication
(10) Pub. No.: US 2017/0108452 A1
(43) Pub. Date: Apr. 20, 2017

(54) Time of Flight Sensor Device Configured to Measure a Characteristic of a Selected Medium

(71) Applicant: Solvz Inc.

(72) Inventor: Jay D. Carlson, Lincoln, NE (US)

(73) Assignee: Solvz Inc., Lincoln, NE (US)

(21) Appl. No.: 15/297,795

(22) Filed: Oct. 19, 2016

Related U.S. Application Data
(60) Provisional application No. 62/243,515, filed on Oct. 19, 2015.

(51) Int. Cl. G01N 22/04; G01S 13/88

(52) U.S. Cl. CPC G01N 22/04; G01S 13/88; H04W 84/18

(57) ABSTRACT

Embodiments of devices, systems, and methods are disclosed that may be used to determine moisture content or chemical composition of a selected medium, such as soil. In an embodiment, a sensor device may include a first transducer configured to send data at a first time to a second transducer through a selected medium and to receive data at a second time from the second transducer through the selected medium. The sensor device may further include a controller coupled to the first transducer and configured to determine a propagation delay through the selected medium based on a difference between the first time and the second time and based on a pre-determined delay time. In some embodiments, the controller may control the first transducer to transmit in different frequencies and may determine the chemical composition based on the propagation delay at the different frequencies.

### CROSS-REFERENCE TO RELATED APPLICATION(S)

The present disclosure is a non-provisional application of and claims priority to U.S. Provisional Patent Application No. 62/243,515 filed on Oct. 19, 2015 and entitled “Ultra-Wide Band Sensor”, which is incorporated herein by reference in its entirety.

### FIELD

The present disclosure is generally related to sensors for measuring frequency-dependent dielectric properties of a any bulk medium, where the radio waves are not fully attenuated, to determine composition and moisture levels. The bulk medium may include soil, paper, pulp, grains (such as wheat, rice, nuts, corn, and the like), processed timbers, silt, sand, clay, mulch, bio-stock, fruits, melons, vegetables, cereals, rice, granular or powdered materials (such as sugar, flour, and the like), insects and insect larvae, food materials, meat (such as beef, chicken, turkey, poultry products, fish, etc.), other fibrous materials or mixtures, or any combination thereof. Further, the sensors may measure frequency-dependent dielectric properties of various industrial processes and materials, such as coal, limestone, sandstone, concrete, fluid mixtures (such as steam), other materials or compositions, or any combination thereof.

### BACKGROUND

Sensors may be inserted into various compositions, such as soil or other materials, to measure moisture content and other parameters, such as salinity, nitrogen content, potassium content, and the like. However, it is not uncommon for such compositions, only a few centimeters from the sensor, to have no effect on the sensor readings. In general, the measurement of other materials may determine the type of sensor, and the range of the measurement may vary, depending on the physical properties of the material to be measured, including the phase (solid, liquid, or gas) and the material texture (e.g., granular, powder, heterogeneous mixture, and so on).

### SUMMARY

Embodiments of devices, systems, and methods are disclosed that may be used to determine moisture content or chemical composition of a selected medium, such as soil. In an embodiment, a sensor device may include a first transducer configured to send data at a first time to a second transducer through a selected medium and to receive data at a second time from the second transducer through the selected medium. The sensor device may further include a controller coupled to the first transducer and configured to determine a propagation delay through the selected medium based on a difference between the first time and the second time and based on a pre-determined delay time. In some embodiments, the controller may control the first transducer to transmit in different frequencies and may determine the chemical composition based on the propagation delay at the different frequencies.

In some embodiments, a system may include a first sensor device, a second sensor device, and a processor. The first sensor device may include an antenna circuit (or transducer) configured to send and receive packets of data including time stamps through a bulk medium. The second sensor device can include an antenna circuit (or transducer) configured to receive and send packets of data including the time stamps through the bulk medium. The processor may be configured to receive data corresponding to times of flight of the packets of data and to determine one or more characteristics of the bulk medium based on the received data. In some aspects, the processor can be an MCU within one of the first sensor device and the second sensor device. In some aspects, the processor can be included within a computing device configured to communicate with the first and second sensor devices.

In other embodiments, a system may include a first sensor device configured to send and receive packets through a selected medium. The first sensor device may include a first antenna circuit at a first depth within the selected medium, a second antenna circuit at a second depth within the selected medium, and a controller coupled to the first and second antenna circuits. The controller may be configured to determine one or more characteristics associated with the selected medium based on a time of flight of the packets and based on a pre-determined delay.

In still other embodiments, a method may include sending a first packet of data through a selected medium from a first sensor device toward a second sensor device and receiving a second packet of data through the selected medium at the first sensor device from the second sensor device. The method may further include determining a time of flight based on a send time, a receive time, and a pre-determined delay. The method may also include determining at least one of a moisture content and a chemistry of the selected medium based on the time of flight.

### BRIEF DESCRIPTION OF THE DRAWINGS

Novel features of this disclosure can be readily understood from the accompanying drawings, taken in conjunction with the description below, in which reference characters may be re-used to refer to similar parts.

FIG. 1 depicts a block diagram of a system including a plurality of sensor devices, in accordance with certain embodiments of the present disclosure.

FIG. 2 depicts is a block diagram of a system including a plurality of sensor devices, in accordance with certain embodiments of the present disclosure.

FIG. 3A illustrates a pair of sensor devices inserted into a bulk material, such as soil, in accordance with certain embodiments of the present disclosure.

FIG. 3B depicts a block diagram of a sensor device, in accordance with certain embodiments of the present disclosure.

FIG. 4 depicts a block diagram of a system including sensor devices configured to transmit packets, in accordance with certain embodiments of the present disclosure.

FIG. 5 depicts a flow diagram of a method of receiving and sending packets using a sensor device, in accordance with certain embodiments of the present disclosure.

FIG. 6 depicts a flow diagram of a method of determining one or more characteristics of a bulk medium based on times of flight of radio frequency signals, in accordance with certain embodiments of the present disclosure.

FIG. 7 depicts a flow diagram of a method of providing data related to the determination of one or more characteristics of a bulk material, in accordance with certain embodiments of the present disclosure.

FIG. 8 depicts a flow diagram of a method of determining a propagation time based on the time difference between transmission and reception of a packet, in accordance with certain embodiments of the present disclosure.

### DETAILED DESCRIPTION OF ILLUSTRATIVE EMBODIMENTS

The dielectric constant (or permittivity) of a bulk medium or material may be impacted by the chemistry of the bulk medium. The bulk medium or material may include soil, paper, pulp, grains (such as wheat, rice, nuts, corn, and the like), processed timbers, silt, sand, clay, mulch, bio-stock, fruits, melons, vegetables, cereals, rice, granular or powdered materials (such as sugar, flour, and the like), insects and insect larvae, food materials, meat (such as beef, chicken, turkey, poultry products, fish, etc.), other fibrous materials or mixtures, or any combination thereof. Further, the sensors may measure frequency-dependent dielectric properties of various industrial processes and materials, such as coal, limestone, sandstone, concrete, fluid mixtures (such as steam), other materials or compositions, or any combination thereof.

By determining the propagation delay of transmitted packets sent between sensor devices spaced apart by a known distance, the average dielectric constant may be calculated. The chemistry or composition of the bulk medium may be inferred based on the dielectric constant.

Embodiments of a system, devices, and methods are described below that can be configured to measure various parameters of any heterogeneous bulk medium, such as those described above, provided the radio waves are not fully attenuated by the material. In some embodiments, the system may utilize two or more independent wireless sensor motes that can be inserted into the bulk medium, spaced apart by a known separation distance, such as thirty (30) centimeters or more. The sensor motes may send and receive radio frequency signals to and from one another, and the system may determine the content of the bulk medium based on the time of flight of the signals. The content may include moisture content, salinity content, nitrogen content, potassium content, and so on. In some embodiments, the sensor motes may transmit radio frequency signals at a first frequency and then at a second frequency and the system may utilize both attenuation of the signal data and time of flight to determine one or more characteristics of the bulk material. Further, in some embodiments, the sensor motes may transmit radio frequency signals at multiple levels for different depths and for different measurement lengths. Other embodiments are also possible.

In certain embodiments, the wireless sensor motes may be configured to measure parameters by measuring the time-of-flight (ToF) of radio frequency signals, such as ultra-wideband signals, traveling through the heterogeneous bulk medium between the deployed motes. In certain embodiments, the ToF may be measured according to IEEE 802.15.4 UWB standards. In other embodiments, the ToF may be measured using other standards or a proprietary standard. In an example, a timestamped packet may be sent from one wireless sensor mote to a second wireless sensor mote. The second wireless sensor mote may receive the packet, wait for a known, fixed amount of time, and then send a return packet to the first wireless sensor mote. The first wireless sensor mote may record the time the return packet was received, and may determine the propagation time based on the timing of the received packet relative to the time at which the first packet was sent and based on the known, fixed amount of time of the delay. It should be appreciated that the propagation time is approximately half of the remaining time after subtracting the delay period from the round trip time (e.g., Total time−known delay period=remaining time).

The propagation time of the packet is the speed of light multiplied by the distance between the two wireless sensor motes. The speed of light is

$$c = \frac{1}{\sqrt{{μ}_{0} {ɛ}_{r} {ɛ}_{0}}} \qquad ( 1 )$$

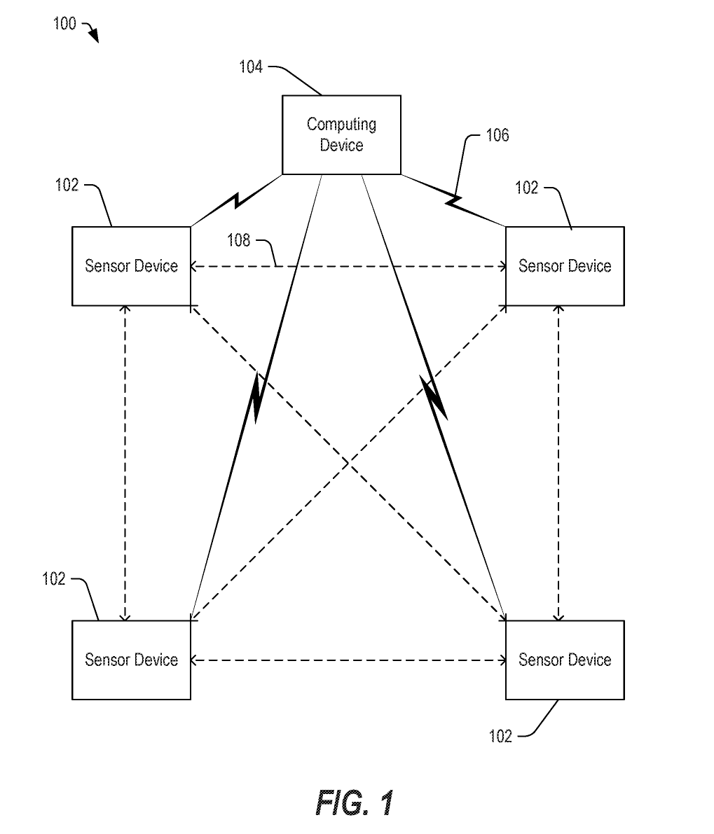

In a vacuum, the variable ∈ᵣ=1 (by definition). In any other medium, such as soil, concrete, sugar, flour, various mixtures, and so on, the relative permittivity (an expression of the dielectric constant relative to the dielectric constant of a vacuum) depends on the composition and chemistry of the medium. The dielectric constant of soil can be strongly affected by soil characteristics (contents and composition), including moisture content. Further, the dielectric constant may vary across frequencies, and certain frequencies may be attenuated differently by different material components. In certain embodiments, the system may utilize frequency diversity to produce frequency-dependent dielectric measurements, which can provide additional data about soil characteristics. One possible example of a system that can be used to determine characteristics of a bulk medium is described below with respect to FIG. 1.

FIG. 1 depicts a block diagram of a system 100 including a plurality of sensor devices 102, in accordance with certain embodiments of the present disclosure. The plurality of sensor devices 102 may be configured to communicate with a computing device 104 through communications links 106, which may be wired or wireless. Further, the sensor devices 102 may send and receive data packets through a bulk medium, mixture, or composition (such as clay, soil, etc.) to one another via wireless communication paths 108. In certain embodiments, the sensor devices 102 may transmit radio frequency (RF) signals through the bulk material at two or more depths to provide information about the permittivity of the bulk material at different depths. Further, the sensor devices 102 vary their transmission frequencies to analyze the permittivity of the transmission medium at different frequencies. The time of flight for the RF signals through the bulk medium at different depths and at different frequencies enables the system to determine characteristics of the bulk medium, such as determining particular constituents of the medium, such as moisture, types of rocks, types or volume of various materials, and so on.

In certain embodiments, a first sensor device 102 may send a time-stamped data packet to a second sensor device 102. The second sensor device 102 may delay for a pre-determined period of time, and then may send a second data packet to the first sensor device 102 with a new time stamp. The first sensor device 102 may determine a propagation delay of the packet transmission by subtracting the receive time of the second packet from the transmission time of the first packet to determine a total time, and then by subtracting the pre-determined delay from the total time to determine a travel time. The travel time represents the propagation time for the signal to travel to the destination and back, so the one-way propagation time is the travel time divided by two. Other embodiments are also possible.

Based on the determined propagation time, the computing system 104 may be configured to determine moisture content of the mixture. In particular, moisture content of the soil alters the permittivity as compared to dry soil, making it possible to infer the relative moisture content of the medium based on the differences. Further, in some embodiments, the sensor devices 102 may be configured to vary the frequency of the packet transmissions, and the propagation delay may vary at the different frequencies, depending on the composition of the mixture, making it possible for the sensor devices 102 to determine moisture content and other parameters of the mixture. In a particular example, moisture, types of clay, obstructions (such as rocks, tree roots and so on), biodegradable material, insects, and other components of the bulk material may impact the attenuation of the signal differently at different frequencies and may impact the time of flight, making it possible to infer the components of the bulk material from the difference in the time of flight.

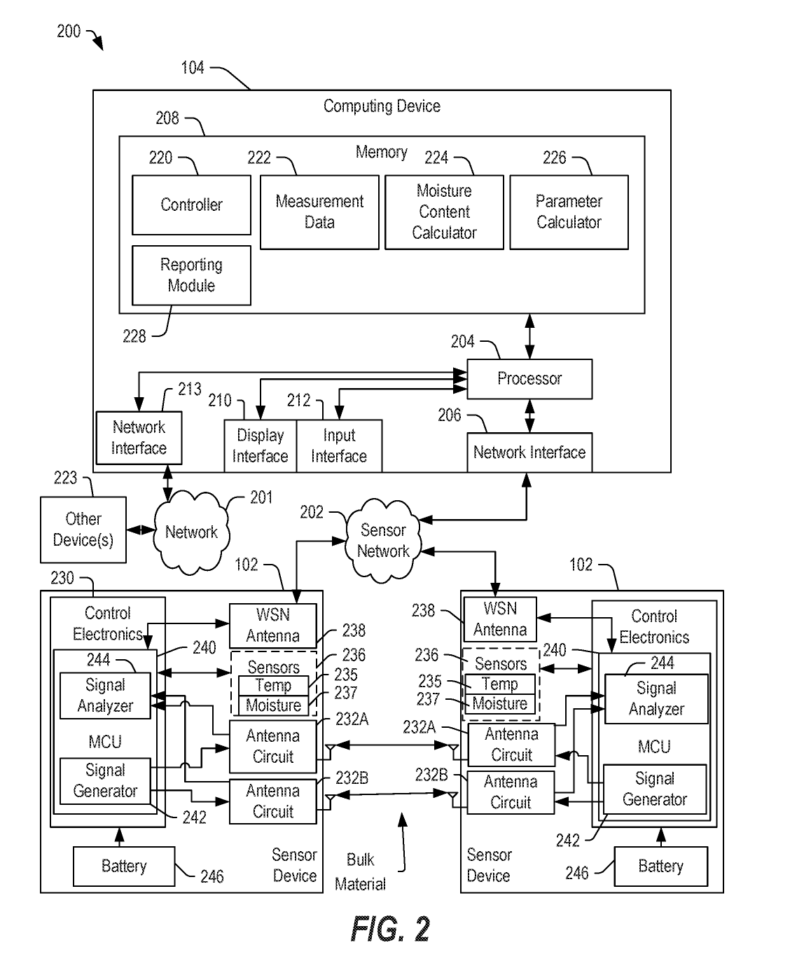

In certain embodiments, the time of flight represents the speed of light through a material other than a vacuum. The components of the bulk material impact the permittivity, which alters the time of flight. In some embodiments, the sensor devices 102 may include directional antennas configured to send and receive RF signals toward another sensor device 102. Additionally, in some embodiments, the sensor devices 102 may be configured to communicate raw data to a computing system to process the data to determine the time of flight and to infer characteristics of the bulk medium. In other embodiments, the sensor devices 102 may be configured to process the time of flight data to determine the characteristics of the bulk medium and may communicate the characteristics, the time of flight data, or any combination thereof to a computing device. In still other embodiments, the sensor devices 102 and a computing system may determine characteristics of the bulk material. One possible example of a system including sensor devices 102 and the computing device 104 is described below with respect to FIG. 2.

FIG. 2 is a block diagram of a system 200 including a plurality of sensors 102, in accordance with certain embodiments of the present disclosure. The system 200 may include the computing device 104 and sensor devices 102. In the illustrated example, the sensor devices 102 may communicate with the computing device 104 through a sensor network 202. In some embodiments, the sensor network 202 may include a short-range wireless network, a cellular network, a digital network, and satellite network, another data or communications network, or any combination thereof. In some embodiments, the computing device 104 may include a laptop computer, a tablet computer, a notebook computer, a desktop computer, a smart phone, another data processing device, or any combination thereof.

The computing device 104 may include a processor 204 configured to communicate with the sensor devices 102 through a network interface 206, which may be configured to communicate with the sensor network 202. The processor 204 may also be coupled to a memory 208 configured to store data and instructions. Further, the processor 204 may be coupled to a display interface 210 and to an input interface 212, which interfaces 210 and 212 may be implemented as a touchscreen interface. Further, the computing device 104 may include a network interface 213, which may be configured to communicatively couple the computing device 104 to a network 201, such as a local area network, a wide area network (such as the Internet or another communications network), or any combination thereof. The computing device 104 may communicate data, reports, a website interface, or any combination thereof to one or more other devices 223 via the network 201. Other embodiments are also possible.

The memory 208 may include controller instructions 220 that, when executed, control operation of the computing device 104 and optionally one or more of the sensor devices 102. In an example, the controller instructions 220 may cause the processor 204 to send control signals to the sensor devices 102 to initiate transmission and reception of RF signals, to determine a time of flight of such RF signals, and to communicate data related to the time of flight to the computing device 104.

Further, the memory 208 may store measurement data 222 received from the sensor devices 102. The measurement data 222 may include raw time of flight measurement data, signal strength data, processed data corresponding to the RF signals sent between the sensor devices 102, or any combination thereof. In an example, the measurement data 222 may include inferred information about the component content of the bulk material.

Further, the memory 208 may store a moisture content calculator 224 that, when executed, may cause the processor 204 to calculate the moisture content of a mixture under test based on the propagation delay of packets sent between the sensor devices 102. In an example, the moisture content calculator 224 may be configured to calculate a permittivity associated the bulk material based on time of flight information received from the sensor devices 102 and may cause the processor to infer the moisture content based on the permittivity.

Additionally, the memory 208 may include a parameter calculator 226 that, when executed, may cause the processor 204 to determine one or more components of the mixture based, at least in part, on the propagation delay of packets sent between the sensor devices 102. In an example, time of flight data for RF signals at different frequencies may be processed to determine particular content or components of the bulk material based on the differences, since different materials may have different impacts on the RF signal based on the frequency. Other embodiments are also possible.

The memory 208 may also include a reporting module 228 that, when executed, may cause the processor 204 to provide data related to the time of flight measurements to the display interface 210 or to another device. In some embodiments, the reporting module 228 may send data related to the characteristics of the bulk material to one or more other devices via the network 201. In an example, the data may be presented within an interface, such as a website interface that can be rendered within an Internet browser application executing on one of the other devices 223. In another example, the data may be sent to one or more of the other devices 223 as part of a text message, an email message, or another type of message, such as via an application protocol interface (API). In another embodiments, the computing device 104 may include one or more visual or audio indicators, which may be controlled by the processor 204 (executing the reporting module 228) to provide an indication of the characteristics of the bulk medium (such as by turning on or turning off particular light-emitting diodes (LEDs), by controlling a speaker to provide an audio alert, a display interface 210, another visible indication, or any combination thereof).

The sensor device 102 may include control electronics 230, which may include a microcontroller unit (MCU) 240 and associated memory (such as a flash memory or other non-volatile memory configured to store instructions, such as firmware, for controlling operation of the sensor device 102). In some embodiments, the MCU 240 may be configured to execute firmware to generate signals (such as by executing a set of instructions that implement a signal generator 242) and to analyze signals (such as by executing a set of instructions that implement a signal analyzer 244). In an alternative embodiment, the signal generator 242 and the signal analyzer 244 may be implemented as circuits. In some embodiments, the MCU 242 may be configured to produce a signal in response to instructions received from the computing device 104. The sensor device 102 may further include a power source, such as a battery 246, which may supply power to the control electronics 230, which may route power to the various components.

In certain embodiments, the sensor device 102 may include a first antenna circuit 232A and a second antenna circuit 232B, which may be transducers configured to convert electrical signals into radio frequency signals. The first antenna circuit 232A may include an input coupled to an output of the signal generator 242 and an output coupled to an input of the signal analyzer 244. The second antenna circuit 232B may include an input coupled to an output of the signal generator 242 and an output coupled to an input of the signal analyzer 244.

In some embodiments, the first and second antenna circuits 232A and 232B may be spaced apart from one another by a known distance, enabling transmission and reception of RF signals at different depths. In some embodiments, the first and second antenna circuits 232A and 232B may be directional antennas, which is an antenna that can radiate or receive signals with greater power in specific directions. In some embodiments, the first and second antenna circuits 232A and 232B may be configured to send and receive packets through a bulk medium, such as soil, compost, or another composition. The packets may include time stamps, which can be used to determine a time of flight of each packet. Further, in some embodiments, the MCU 240 may be configured to control the circuits 232 to send and receive packets at different frequencies, which may also be used to determine characteristics of the bulk material.

In some embodiments, the sensor device 102 may include one or more sensors 236. In an example, the one or more sensors 236 may include a temperature sensor 235 and a moisture sensor 237 to detect if the housing of the sensor device 102 may be leaking. Other sensors may also be included, such as an altimeter, a directional sensor (e.g., a compass), a humidity sensor, a barometric pressure sensor, a proximity sensor, a weight sensor, a bulk density sensor, and other sensors. In an example, the directional sensor can be used to direct one sensor toward another sensor. Other sensors and other functionality are also possible. In a particular embodiment, a proximity sensor can determine a distance between sensor devices 102 can allow for a variable measurement of probe distances. In some examples, an orientation sensor may be used to determine if the probes are installed in a correct orientation.

In some embodiments, the sensor device 102 may further include a wireless sensor network (WSN) antenna 238 coupled to the MCU 240 and configured to communicate with the computing device 104 through a sensor network 202. In some embodiments, the MCU 240 may communicate data and receive instructions from the computing device 104 via the WSN antenna 238 through the sensor network 202 or through another wireless communications link (such as the network 201 or another short-range wireless connection). Other embodiments are also possible.

In some embodiments, the first circuit 232A may be positioned at a first level within a bulk medium (such as soil or another mixture) and the second circuit 232B may be positioned at a second level within the bulk medium. In a particular example, the sensor device 102 may be implemented as a stick that can be inserted into the bulk medium to a selected depth, and the circuits 232 may be at different levels within the bulk medium to determine signal propagation delays at different depths, which signal propagation delays may be used to determine moisture content or other constituents of the mixture.

The second sensor device 102 may be implemented as a stick that can also be inserted into the bulk medium to a selected depth, which may correspond to the depth of the first sensor. Further, the circuits 232 within the sensor device 102 may be at different levels (or depths) within the bulk medium. The first and second sensor devices 102 may transmit time stamped data packets toward one another, and may receive time stamped data packets from one another. In some embodiments, each sensor device 102 is configured to receive a packet, wait for a pre-determined period of time (delay period), and then send the packet back to the original sender device. The total time of flight of the packet may be determined based on the total time minus the delay period. The time of flight of the packet in one direction may be determined by dividing the total time of flight in half. The resulting time of flight determination may be used to infer the content of the bulk material (such as moisture content, material content, or any combination thereof). Other embodiments are also possible.

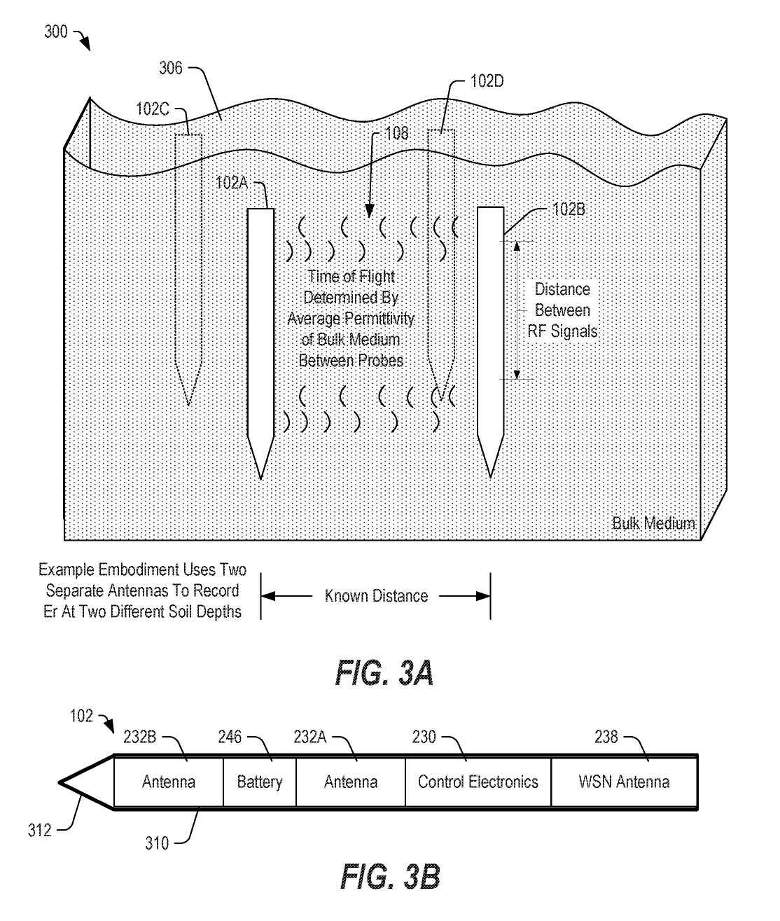

FIG. 3A is a diagram 300 including a pair of sensor devices 102A and 102B inserted into a composition (or bulk medium) 306, such as soil, compost, or another heterogeneous mixture, in accordance with certain embodiments of the present disclosure. In the illustrated example of FIG. 3A, four sensor devices 102 are shown, which devices 102 may send RF signals to and receive RF signals from one another, and the time of flight of the RF signals may be used to determine one or more characteristics of the bulk medium, such as moisture content, mixture components, other parameters, or any combination thereof. In the following discussion, only the foremost sensor devices 102A and 102B are discussed; however, the same discussion applies to the sensor devices 102C and 102D. Further, sensor device 102C may send and receive signals to and from sensor device 102A, sensor device 102B, sensor device 102D, or any combination thereof. Further, sensor device 102D may send and receive signals to and from sensor device 102A, sensor device 102B, sensor device 102C, or any combination thereof.

The sensor devices 102A and 102B may send and receive packets 108. In certain embodiments, an array of sensors 102 may be inserted into the composition 306. The sensor devices 102A and 102B may be separated by a known distance. The propagation delay of each of a plurality of packets may be determined, and the relative permittivity (dielectric constant) of the mixture may be determined between the probes based on the propagation delay (i.e., time of flight (ToF)).

In certain embodiments, two separate antennas are included in each of the sensor devices 102A and 102B in order to send and receive packets at two different depths within the mixture. The packets may be received with different propagation delays indicating different mixture compositions, different moisture content, or any combination thereof at the different depths within the composition 306. In some embodiments, the sensor devices 102A and 102B may include additional antennas to provide propagation delay readings at additional depths within the mixture.

FIG. 3B is a block diagram of sensor device 102, in accordance with certain embodiments of the present disclosure. The sensor device 102 may be implemented as a stick or other structure that may be inserted into a mixture. The sensor device 102 may include first and second antennas 232A and 232B, a battery 246, control electronics 230, and a WSN antenna 238. As shown, the sensor device 102 may include a housing 310, which may be sealed to prevent moisture from reaching the circuitry. The housing 310 may include a point or tip 312, which may be inserted into a mixture. In some embodiments, the housing 310 may define an enclosure sized to receive the electronics. Further, the housing 310 may be formed from a material that allows for transmission and reception of wireless signals and that protects the electronics from moisture and other contaminants.

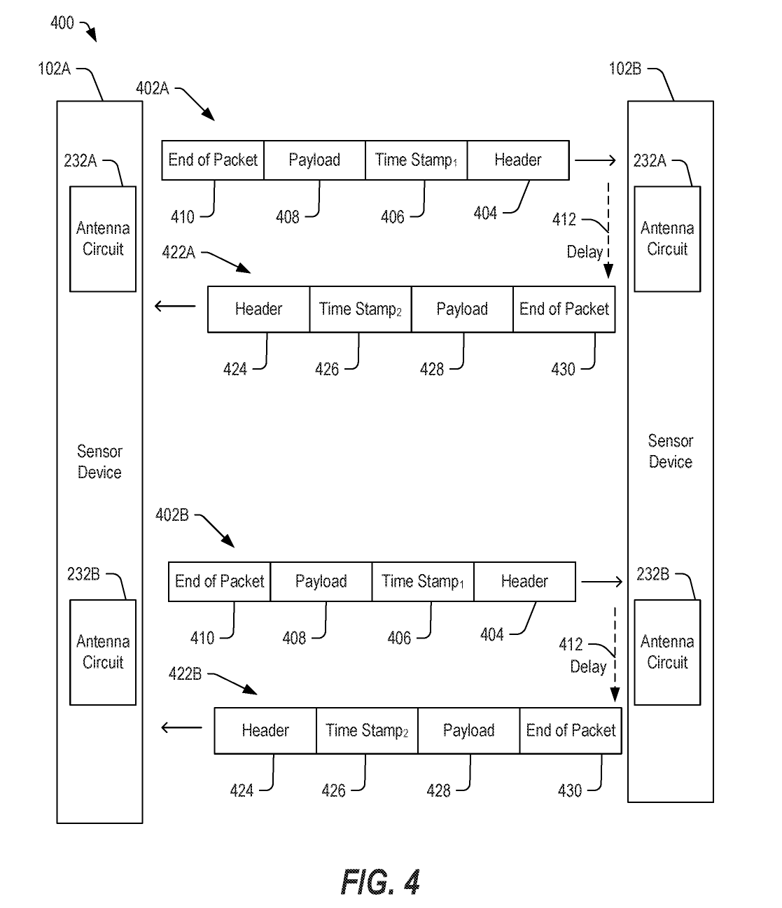

FIG. 4 is a block diagram of a system 400 including sensor devices 102A and 102B configured to transmit packets 402 and 422, in accordance with certain embodiments of the present disclosure. In certain embodiments, the sensor device 102A may utilize a antenna circuit 232A send a first packet 402A to the sensor device 102B. The first packet 402A (or any packet 402 sent through the bulk medium using the antenna circuits 232) may include a header 404, a first time stamp 406, a payload 408, and an end of packet 410. In some embodiments, the time stamp may be omitted, and the sensor device 102A may record its own transmission time without sending the time stamp. Further, in some embodiments, the payload 408 may be omitted, and the packet 402 may include the header 404, the end of packet 410, another field, or any combination thereof. Other embodiments are also possible.

The sensor device 102B may receive the first packet 402A using the antenna circuit 232A. In response to receiving the first packet 402, the sensor device 102B may delay for a pre-determined period of time (as generally indicated at 412). After pre-determined period of time has expired, the sensor device 102B may utilize the antenna circuit 232A to send a second packet 422 to the sensor device 102A. The second packet 422 may include a header 424, a time stamp 426, a payload 428, and an end of packet 430, or any combination thereof. In a particular embodiment, the time stamp 426 may correspond to the time stamp 406, allowing the sensor device 102A to utilize the time stamp data to determine the total time of flight.

In certain embodiments, the sensor device 102A may determine a total time based on a difference between the time the packet 402 was sent and the time when the packet 422 was received. Further, the sensor device 102A may subtract the known delay time from the total time to determine a round trip propagation time. The sensor device 102A may determine moisture content, mixture components, or any combination thereof based on the round trip propagation time. Other embodiments are also possible.

It should be appreciated that, in the illustrated example, both of the sensor devices 102A and 102B include two antenna circuits 232, i.e., 232A and 232B. In some embodiments, the antenna circuits 232A and 232B may be separated by a pre-determined distance within the sensor devices 102A and 102B, making it possible to send and receive packets at different depths. The first packet 402A and the second packet 402B may be sent asynchronously. Other embodiments are also possible.

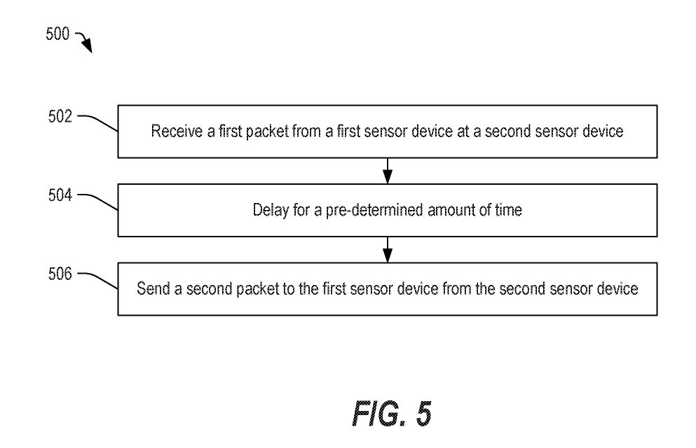

FIG. 5 is a flow diagram of a method 500 of receiving and sending packets using a sensor device, in accordance with certain embodiments of the present disclosure. At 502, the method 500 may include receiving a first packet from a first sensor device at a second sensor device. In certain embodiments, the first packet may include a time stamp. At 504, the method 500 may further include delaying for a pre-determined amount of time. During the delay period, the sensor device may prepare a packet for transmission. The prepared packet may include the time stamp of the received packet. At 506, the method 500 may include sending a second packet to the first sensor device from the second sensor device.

In certain embodiments, the first sensor device may determine a propagation delay based on the time that the first packet was sent, the time that the second packet was received, and the pre-determined amount of time that the second sensor device delayed before sending the second packet. Other embodiments are also possible.

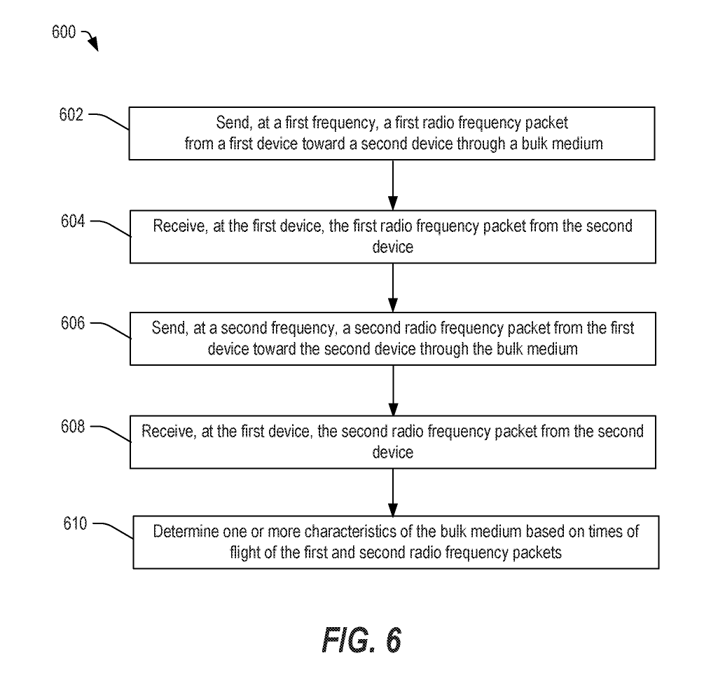

FIG. 6 depicts a flow diagram of a method 600 of determining one or more characteristics of a bulk medium based on times of flight of radio frequency signals, in accordance with certain embodiments of the present disclosure. At 602, the method 600 may include sending, at a first frequency, a first radio frequency packet from a first device toward a second device through a bulk medium. The first device and the second device may be embodiments of a sensor device 102 as discussed above with respect to FIGS. 1-4.

At 604, the method 600 may include receiving, at the first device, the first radio frequency packet from the second device. As discussed above, the second device may delay the sending of the packet by a pre-determined amount of time.

At 606, the method 600 can include sending, at a second frequency, a second radio frequency packet from the first device toward the second device. At 608, the method 600 can include receiving, at the first device, the second radio frequency packet from the second device. As discussed above, the second device may again delay the sending of the packet by a pre-determined amount of time.

At 610, the method 600 may include determining one or more characteristics of the bulk medium based on times of flight of the first and second radio frequency packets. The times of flight may be determined by an MCU of the first device or may be determined by a computing device based on data received from the first device. Other embodiments are also possible.

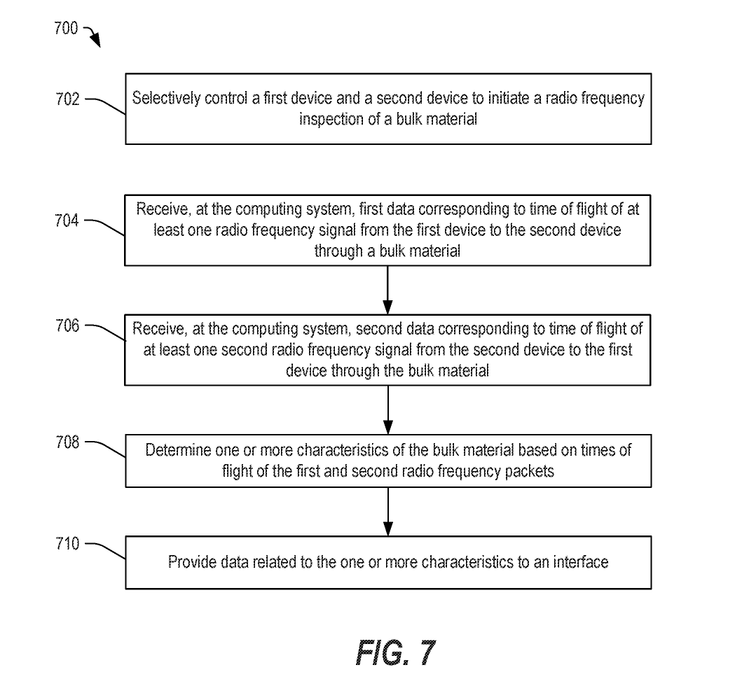

FIG. 7 depicts a flow diagram of a method 700 of providing data related to the determination of one or more characteristics of a bulk material, in accordance with certain embodiments of the present disclosure. At 702, the method 700 may include selectively controlling a first device and a second device to initiate a radio frequency inspection of a bulk material. At 704, the method 700 can include receiving, at the computing device, first data corresponding to time of flight of at least one radio frequency signal from the first device to the second device through a bulk material. In some embodiments, the first data may include time of flight data. In other embodiments, the first data may include raw data corresponding to the transmission and reception of data packets. At 706, the method 700 may include receiving, at the computing device, second data corresponding to time of flight of at least one second radio frequency signal from the first device to the second device through the bulk material.

At 708, the method 700 can include determining one or more characteristics of the bulk material based on times of flight of the first and second radio frequency packets. The characteristics can include the moisture content of the bulk material, which may be based on the time of flight.

At 710, the method 700 can include providing data related to the one or more characteristics to an interface. The data may be sent via a text message or may be presented within a graphical user interface, such as a web page interface that can be rendered within a browser application of a computing device, such as a smart phone, a tablet computer, a laptop computer, or another computing device.

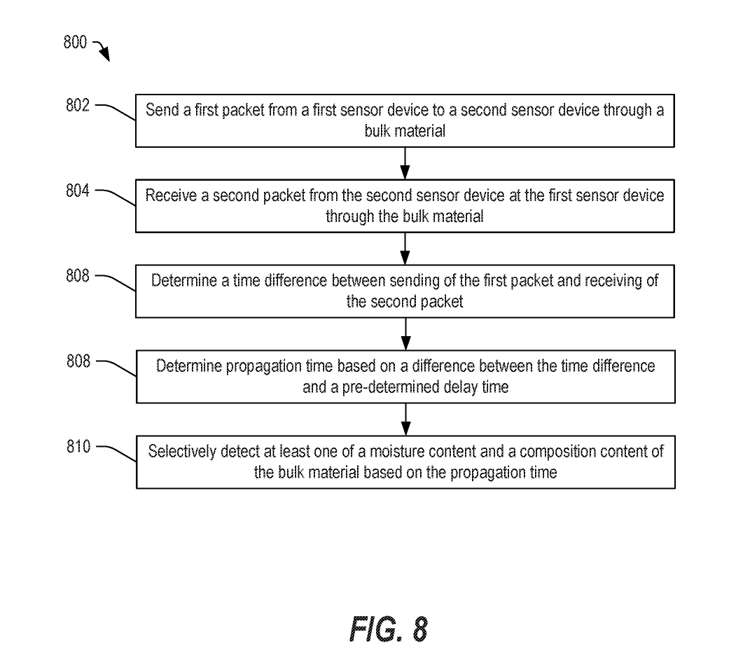

FIG. 8 is a flow diagram of a method 800 of determining a propagation time based on the time difference between transmission and reception of a packet, in accordance with certain embodiments of the present disclosure. At 802, the method 800 may include sending a first packet from a first sensor device to a second sensor device through a bulk material. At 804, the method 800 may further include receiving a second packet from the second sensor device through the bulk material.

At 806, the method 800 may include determining a time difference between sending of the first packet and receiving of the second packet. At 808, the method 800 may further include determining a propagation time based on a difference between the time difference and a pre-determined delay time. At 810, the method 800 can include selectively detecting at least one of moisture content and a composition content based on the propagation time. In some embodiments, the moisture content or composition of a mixture may be determined based on the propagation time, because such content may impact the dielectric of the mixture. Other embodiments are also possible.

In some examples, a packet of data may be sent from a first device to a second device, which may delay by a pre-determined period of time before sending the packet back to the first device. In some examples, multiple packets of data may be sent between two devices at one or more frequencies, and the times of flight of the multiple packets may be used to determine one or more characteristics of the bulk medium.

In conjunction with the devices, systems and methods described above with respect to FIGS. 1-8, a sensor device is described that can be used to determine content or chemistry of a mixture (e.g., soil, sand, pulp, processed timber, etc.) based on propagation delays (time of flight) of packets transmitted through the mixture. The sensor device provides a number of advantages over conventional devices. For example, the sensor device inherently averages the soil data between the motes, which can be hundreds of centimeters apart. Conventional sensors may only monitor soil content within a very limited range immediately adjacent to the sensor. Soil only a few centimeters away may have no impact on the sensor reading. Accordingly, the averaging provided by the sensor devices can determine such parameters or characteristics over an area.

Further, since the propagation delay (time of flight) is caused the variable dielectric between the sensor motes, the sensor device effectively calculates an “average” dielectric constant from the round-trip time. This “average” dielectric constant represents the average soil conditions between the two motes. Further, the average dielectric constant may represent the soil contents. Further, the signal generators of the sensor devices may be configured to utilize frequency diversity to obtain more information about the soil than simply the moisture content. Certain chemical components may impact the dielectric constant of the mixture differently at different frequencies.

While the above discussion focused on packet transmissions, in some embodiments, data may be transmitted in a variety of signal formats and at various frequencies rather than in packets. The transmission time and the receive time of the data (in addition to the pre-determined delay) may be used to determine the propagation delay. In some embodiments, the transmitted data may be sent back in the return packet. Further, in some implementations, the sensor devices 102 described herein may include ultra-wide band (UWB) antennas. Other types of antennas and transmission devices may also be used.

Although the present disclosure has been described with reference to preferred embodiments, workers skilled in the art will recognize that changes may be made in form and detail without departing from the scope of the invention.

What is claimed is:

1. A system comprises:
a first sensor device including an antenna circuit configured to send and receive packets of data including time stamps through a bulk medium;
a second sensor device including an antenna circuit configured to receive and send packets of data including the time stamps through the bulk medium; and
a processor configured to receive data corresponding to times of flight of the packets of data and to determine one or more characteristics of the bulk medium based on the received data.

2. The system of claim 1, wherein the one or more characteristics includes a moisture content of the bulk medium.

3. The system of claim 1, wherein each of the antenna circuits includes a directional antenna configured to send and receive radio frequency signals in a selected direction.

4. The system of claim 1, wherein the bulk medium comprises at least one of soil, paper, pulp, grains, processed timbers, silt, sand, clay, mulch, bio-stock, fruits, melons, vegetables, cereals, rice, granular materials, powdered materials, insects, insect larvae, compost, food materials, poultry other fibrous mixtures, coal, limestone, sandstone, concrete, and fluid mixtures.

5. The system of claim 1, wherein the bulk medium comprises a mixture.

6. The system of claim 1, wherein each of the first sensor device and the second sensor device includes a network interface configured to communicate with a computing device through a network.

7. The system of claim 6, further comprising:
the computing device; and
wherein the processor is included in at least one of the first sensor device, the second sensor device, and the computing device.

8. The system of claim 1, wherein the first sensor device is configured to send a first packet at a first time to the second sensor device through the bulk medium and to receive a second data packet at a second time from the second sensor device through the bulk medium.

9. The system of claim 8, wherein the first sensor device further includes a controller coupled to the antenna circuit and configured to determine a propagation delay through the bulk medium based on a difference between the first time and the second time and based on a pre-determined delay time.

10. The system of claim 9, wherein the controller is configured to:
send the data at different frequencies;
determine propagation delays at each frequency; and
determine a chemistry of the bulk medium based in part on the propagation delays.

11. The system of claim 1, wherein each of the first sensor device and the second sensor device includes:
the antenna circuit configured to transmit data packets at a first depth within the bulk medium; and
a second antenna circuit configured to transmit data packets at a second depth within the bulk medium, the second depth different from the first depth.

12. A system comprising:
a first sensor device configured to send and receive packets through a selected medium, the first sensor device including:
a first antenna circuit at a first depth within the selected medium;
a second antenna circuit at a second depth within the selected medium; and
a controller coupled to the first and second antenna circuits and configured to determine one or more characteristics associated with the selected medium based on a time of flight of the packets and based on a pre-determined delay.

13. The system of claim 12, wherein the one or more characteristics includes a moisture content of the bulk medium.

14. The system of claim 12, wherein each of the first and second antenna circuits includes a directional antenna configured to send and receive radio frequency signals in a selected direction.

15. The system of claim 12, wherein the selected medium comprises a mixture including at least one of soil, paper, pulp, grains, processed timbers, silt, sand, clay, mulch, bio-stock, fruits, melons, vegetables, cereals, rice, granular materials, powdered materials, insects, insect larvae, compost, food materials, poultry other fibrous mixtures, coal, limestone, sandstone, concrete, and fluid mixtures.

16. The system of claim 12, further comprising further comprising a computing device including a processor configured to determine at least one of a chemistry and a moisture content of the selected medium based on the times of flight data received from the first sensor device and from times of flight data received from one or more second sensor devices.

17. A method comprising:
sending a first packet of data through a selected medium from a first sensor device toward a second sensor device;
receiving a second packet of data through the selected medium at the first sensor device from the second sensor device;
determining a time of flight based on a send time, a receive time, and a pre-determined delay; and
determining at least one of a moisture content and a chemistry of the selected medium based on the time of flight.

18. The method of claim 17, further comprising selectively controlling a frequency of transmission of the first packet.

19. The method of claim 17, wherein sending the first packet and receiving the second packet include sending and receiving at a first depth within the selected medium.

20. The method of claim 19, further comprising:
sending a third packet of data through the selected medium from the first sensor device toward the second sensor device at a second depth that is different from the first depth; and
receiving a fourth packet of data through the selected medium at the first sensor device from the second sensor device at the second depth.
